(19) United States
(12) Patent Application Publication
(10) Pub. No.: US 2018/0211119 A1
(43) Pub. Date: Jul. 26, 2018

(54) Sign Recognition for Autonomous Vehicles

(71) Applicant: Ford Global Technologies, LLC, Dearborn, MI (US)

(72) Inventors: Dongran Liu, San Jose, CA (US); Jinesh J. Jain, Palo Alto, CA (US)

(21) Appl. No.: 15/413,078

(22) Filed: Jan. 23, 2017

(51) Int. Cl. G06K 9/00; G01S 17/89; G01S 17/02; G01S 7/48; G01S 17/93; G06K 9/32; G05D 1/02; B60W 10/20; B60W 10/18; B60W 10/04; B60W 30/09

(52) U.S. Cl. CPC G06K 9/00818; B60W 2710/20; G01S 17/023; G01S 7/4808; G01S 17/936; G06K 9/3258; G06K 9/00805; G05D 1/0214; G05D 1/0231; B60W 10/20; B60W 10/18; B60W 10/04; B60W 30/09; G06K 2209/01; B60W 2550/10; B60W 2720/10; B60W 2710/18; G01S 17/89

(57) ABSTRACT

An autonomous vehicle includes both a LIDAR sensor and a camera. A point cloud from the LIDAR sensor is processed to remove points corresponding to a ground plane and points having a reflectivity below a reflectivity threshold. The remaining points are grouped into clusters. Clusters having points satisfying a flatness threshold are then converted into 2D pixel positions in the output of the camera. Regions of interest including these 2D pixel positions are then analyzed to detect and interpret any road signs present.

### BACKGROUND

### Field of the Invention

This invention relates to identifying road signs by an autonomous vehicle.

### Background of the Invention

Traffic Sign Recognition (TSR) has been a popular topic in the field of autonomous vehicles. The recognition process includes traffic sign detection and traffic sign recognition. With the current state of art machine learning techniques, a traffic sign recognition of over 99% can be achieved. However, it is still difficult to provide a system that can localize the position of a sign fast and accurately. The accuracy and responsiveness of camera based TSR system very much depends on the input image's resolution. However, higher resolution image also causes intensive computation, which slows down the whole system.

The system and method disclosed herein provides an improved approach for traffic sign recognition.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of components implementing an autonomous vehicle in accordance with an embodiment of the present invention;

FIG. 2 is a schematic block diagram of an example computing device suitable for implementing methods in accordance with embodiments of the invention;

FIG. 3 is a process flow diagram of a method for identifying road signs by a controller of an autonomous vehicle in accordance with an embodiment of the present invention; and

FIGS. 4A-4D illustrate the processing of sensor data to identify a portion of an image that is likely to include a road sign in accordance with embodiments of the present invention.

### DETAILED DESCRIPTION

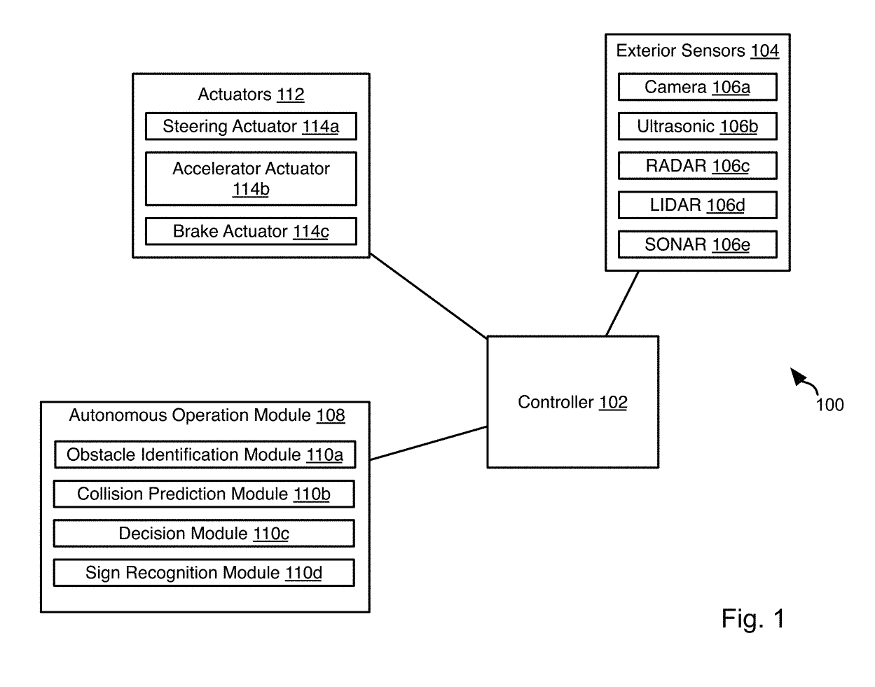

Referring to FIG. 1, a system 100 includes a controller 102 housed within a vehicle. The vehicle may have some or all of the structures and features of any vehicle known in the art including, wheels, a drive train coupled to the wheels, an engine coupled to the drive train, a steering system, a braking system, and other systems known in the art to be included in a vehicle.

As discussed in greater detail herein, the controller 102 may perform autonomous navigation and collision avoidance. The controller 102 may receive one or more outputs from one or more exterior sensors 104. For example, one or more cameras 106a may be mounted to the vehicle and output image streams received to the controller 102.

The exterior sensors 104 may include sensors such as an ultrasonic sensor 106b, a RADAR (Radio Detection and Ranging) sensor 106c, a LIDAR (Light Detection and Ranging) sensor 106d, a SONAR (Sound Navigation and Ranging) sensor 106e, and the like.

The controller 102 may execute an autonomous operation module 108 that receives the outputs of the exterior sensors 104. The autonomous operation module 108 may include an obstacle identification module 110a, a collision prediction module 110b, and a decision module 110c. The obstacle identification module 110a analyzes the outputs of the exterior sensors and identifies potential obstacles, including people, animals, vehicles, buildings, curbs, and other objects and structures. In particular, the obstacle identification module 110a may identify vehicle images in the sensor outputs.

The collision prediction module 110b predicts which obstacle images are likely to collide with the vehicle based on its current trajectory or current intended path. The collision prediction module 110b may evaluate the likelihood of collision with objects identified by the obstacle identification module 110a. The decision module 110c may make a decision to stop, accelerate, turn, etc. in order to avoid obstacles. The manner in which the collision prediction module 110b predicts potential collisions and the manner in which the decision module 110c takes action to avoid potential collisions may be according to any method or system known in the art of autonomous vehicles.

The decision module 110c may control the trajectory of the vehicle by actuating one or more actuators 112 controlling the direction and speed of the vehicle. For example, the actuators 112 may include a steering actuator 114a, an accelerator actuator 114b, and a brake actuator 114c. The configuration of the actuators 114a-114c may be according to any implementation of such actuators known in the art of autonomous vehicles.

In embodiments disclosed herein, the autonomous operation module 108 may perform autonomous navigation to a specified location, autonomous parking, and other automated driving activities known in the art.

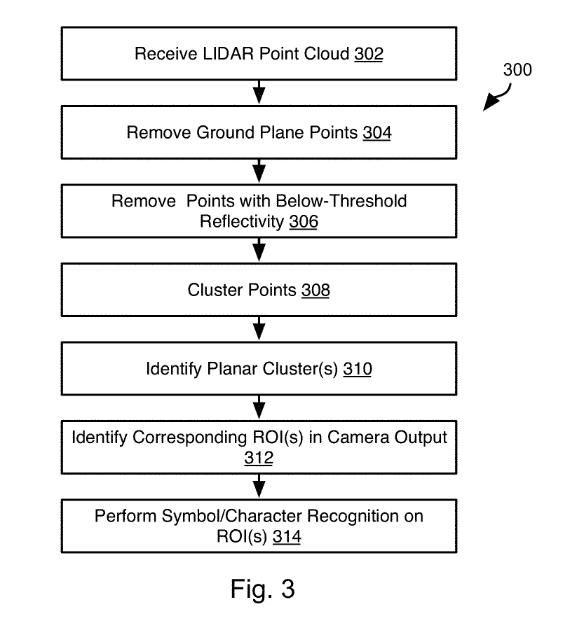

The autonomous operation module 108 may include a sign recognition module 110d. The sign recognition module 110d operates to (1) reduce the area of an image that is analyzed for potential road signs and (2) perform TSR on this reduced area. The sign recognition module 110d may perform these functions according to the method 300 of FIG. 3 described below.

The decision module 110c may receive locations and content of road signs recognized by the sign recognition module 110d. In particular, the decision module 110c may control the speed of the vehicle according to the speed limit extracted from speed limit signs. The decision module 110c may stop in response to detecting stop signs, and yield in response to cross traffic if a yield sign is detected. Other appropriate actions may be taken by the decision module 110c in response to road signs in accordance with traffic laws.

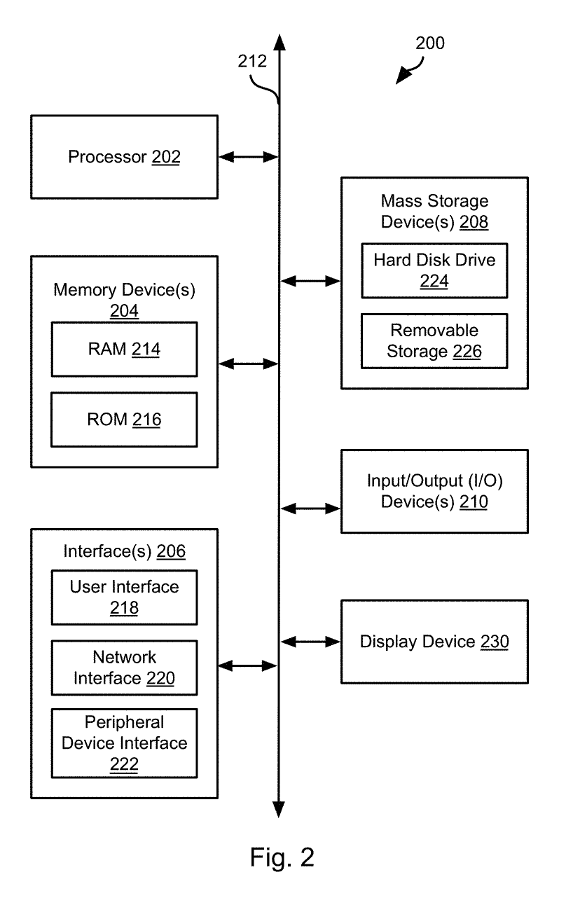

FIG. 2 is a block diagram illustrating an example computing device 200. Computing device 200 may be used to perform various procedures, such as those discussed herein. The controller 102 may have some or all of the attributes of the computing device 200.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, I/O device(s) 210, and display device 230 to communicate with one another, as well as other devices or components coupled to bus 212. Bus 212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Referring to FIG. 3, the controller 102 may execute the illustrated method 300 to identify and interpret road signs in an efficient manner. The method 300 may include receiving 302 a LIDAR point cloud, which is an array of three-dimensional (3D) coordinates that each represent detection of a reflection by the LIDAR sensor 106d from a location corresponding to that 3D coordinate. As known in the art, each coordinate includes a reflectivity value between zero and one, where one indicates perfect reflection and zero indicates no reflection. The LIDAR sensor 106d may operate in the visible light range, IR range, or other range of wavelengths. For example, where signs have IR reflective printing, the IR range may be used.

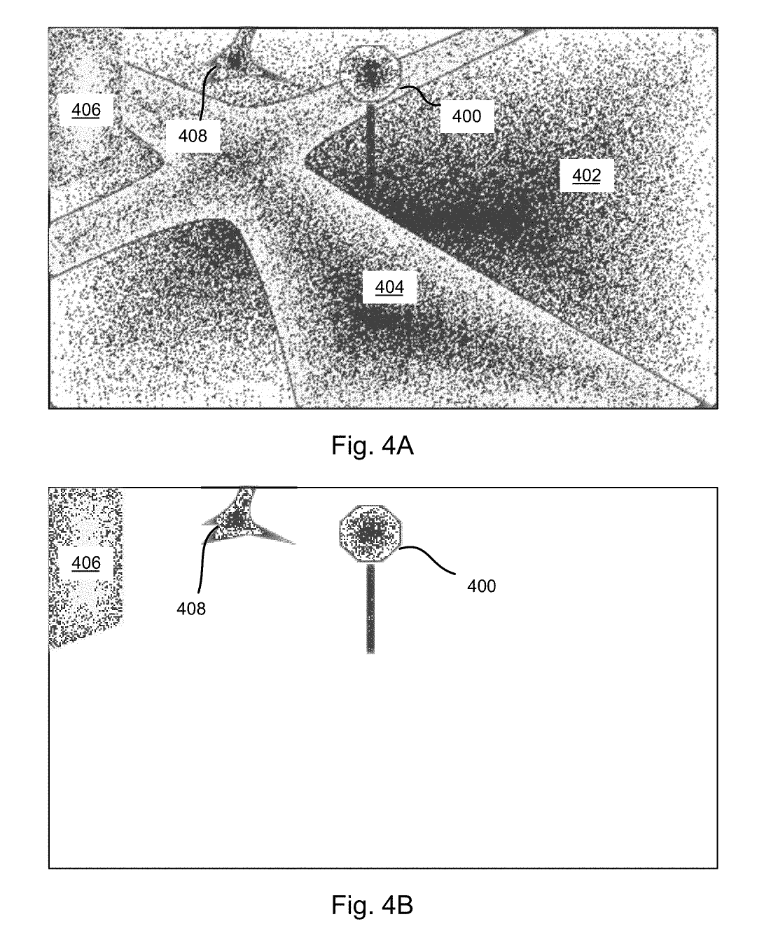

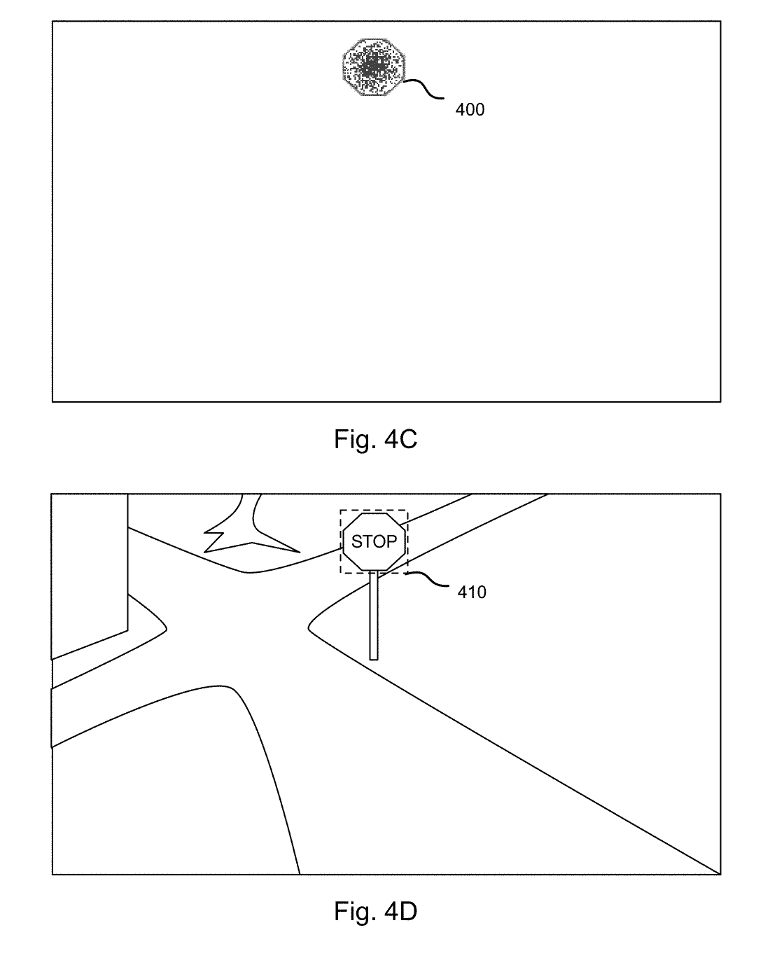

FIG. 4A illustrates a simplified representation of a point cloud. As is apparent, various structures are detected such as a road sign 400, surrounding ground 402 (grass, dirt, asphalt, etc.), a road 404, buildings 406, trees 408, etc. Other non-static objects such as animals, pedestrians, and other vehicles may also be represented by points in the point cloud.

The method 300 may further include removing 304 ground plane points from the point cloud, as shown in FIG. 4B. The manner in which ground plane points are removed may be according to any method known in the art of autonomous vehicles. As shown in FIG. 4B, the points corresponding to the ground 402 and road 404 are removed, leaving various objects 400, 406, 408 that protrude from the ground.

The method 300 further includes removing 306 points having a reflectivity below a reflectivity threshold. As noted above, reflectivity values lie between 0 and 1. Road signs are generally reflective and therefore points remaining after step 306 have a high likelihood of corresponding to road signs. The reflectivity threshold may be a value between 0.5 and 0.9. For example, 0.7 is a workable value. Note that the method 300 is intended to reduce the area of an image that needs to be analyzed to detect road signs. Accordingly, with lowering of the threshold, the number of points that remain to be analyzed will increase but the likelihood of missing a sign is reduced. Accordingly, the threshold may be selected for a given LIDAR sensor 106d and camera 106a based on experimentation in order to achieve a needed level of accuracy while still reducing computational load. As shown in FIG. 4C, the points 400 corresponding to the road sign are the only points remaining following step 306 in the illustrated example.

The method 300 may further include clustering 308 points that remain following step 306. In particular, points that are adjacent to one another may be assigned to the same cluster. Clustering may be performed according to any clustering approach known in the art. In the illustrated embodiment, the proximity of the points corresponding to the road sign 400 will result in them being assigned to a cluster.

The method 300 may further include identifying 310 planar clusters, i.e. clusters having points thereof that meet some flatness criteria. For example, step 310 may include fitting the points of the cluster to a plane (e.g., using a linear least squared approach) and evaluating whether the variation among the points of the cluster with respect to the plane is below the flatness threshold. For example, the cluster may be evaluated with respect to the plane according to a RANSAC (random sample consensus) algorithm. Where an output of the RANSAC algorithm for a cluster does not meet the flatness threshold, the cluster may be removed from further processing according to the method 300.

For each cluster that meet the flatness threshold, the method 300 may include identifying 312 a corresponding region of interest (ROI). As noted above, each cluster is a point of 3D coordinates. These 3D coordinates may be converted into two-dimensional (2D) pixel positions in an image output by the camera 106a. As shown in FIG. 4D, the ROI 410 in the illustrated example includes a rectangular region around the road sign.

The manner in which the 3D coordinates are converted to 2D pixel positions may include any transformation technique known in the art, such as the direct linear transform (DLT), rasterization techniques as known in the art of 3D rendering, or the like. The parameters defining the transformation may be calibrated for the relative positions of the LIDAR 106d and camera 106a and the properties of these devices. Note that the purpose of the method 300 is to reduce the area of an image that is analyzed. Accordingly, a lack in accuracy between 3D coordinates and 2D pixel positions may be compensated by expanding the ROI. As noted above, the ROI for a cluster may be a rectangular region of the camera image such that the 2D pixel positions for all points in the cluster lie within the rectangular region. The ROI may be expended beyond the smallest rectangle encompassing the 2D pixel positions in order to compensate for errors.

The method 300 may then include performing 314 traffic sign recognition (TSR) for one or more ROIs identified at step 312. As known in the art TSR may include performing one or both of symbol and character recognition in order to decode the type and content of the road sign. In the example of FIG. 4D, this may include identifying the octagonal shape and word “STOP” in the ROI 410. Where TSR is performed 314 exclusively for the ROIs identified at step 312, the amount of computational power required to perform TSR is reduced and road signs may be identified more quickly.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

1. A method comprising, by a controller of a vehicle:
identifying clusters of points in a point cloud obtained from a LIDAR (light detection and ranging) sensor, the clusters of points having reflectivity above a reflectivity threshold; and
performing at least one of symbol and character recognition for regions of an output of a camera corresponding to one or more of the clusters of points, the camera and LIDAR sensor being mounted to the vehicle.

2. The method of claim 1, further comprising:
refraining from performing symbol and character recognition for regions of the output of the camera not corresponding to the clusters of points.

3. The method of claim 1, further comprising:
determining that each cluster of a first portion of the clusters of points meets a flatness threshold;
wherein performing at least one of symbol and character recognition exclusively for the regions of the output of the camera corresponding to the one or more of the clusters of points comprises performing at least one of symbol and character recognition exclusively for regions of the output of the camera corresponding to the first portion of the clusters of points.

4. The method of claim 3, further comprising:
refraining from performing symbol and character recognition for regions of the output of the camera corresponding to a second portion of the clusters of points, where each cluster of the second portion does not meet the flatness threshold.

5. The method of claim 1, further comprising:
performing obstacle detection using the point cloud; and
autonomously navigating the vehicle to a destination and avoiding any obstacles determined from performing obstacle detection.

6. The method of claim 5, wherein autonomously navigating the vehicle to the destination comprises activating at least one of a steering actuator, accelerator actuator, and a braking actuator.

7. The method of claim 5, further comprising:
autonomously navigating the vehicle in conformance with information obtained from the at least one of the symbol and character recognition performed on the regions of the output of the camera corresponding to the one or more of the clusters of points.

8. The method of claim 1, wherein performing at least one of symbol and character recognition exclusively for the regions of the output of the camera corresponding to the one or more of the clusters of points comprises:
translating coordinates of points in the one or more of the clusters of points to two-dimensional pixel positions in the output of the camera, the regions including the two-dimensional pixel positions.

9. The method of claim 1, wherein identifying the clusters of points in the point cloud obtained from the LIDAR sensor having reflectivity above the reflectivity threshold comprises:
identifying points in the point cloud having reflectivity above the reflectivity threshold; and
grouping the points into the clusters of points according to proximity of the points of each cluster of points to one another.

10. The method of claim 1, wherein identifying the clusters of points in the point cloud obtained from the LIDAR sensor having reflectivity above the reflectivity threshold comprises:
removing points from the point cloud that correspond to a ground plane; and
identifying the clusters of points from among points of the point cloud that do not correspond to the ground plane.

11. A vehicle comprising:
a camera;
a light detection and ranging (LIDAR) sensor;
a controller coupled to the camera and LIDAR sensor, the controller programmed to:
identify clusters of points in a point cloud obtained from the LIDAR sensor, the clusters of points having reflectivity above a reflectivity threshold; and
perform at least one of symbol and character recognition for regions of an output of a camera corresponding to one or more of the clusters of points.

12. The vehicle of claim 11, wherein the controller is further programmed to:
refrain from performing symbol and character recognition for regions of the output of the camera not corresponding to the clusters of points.

13. The vehicle of claim 11, wherein the controller is further programmed to:
if a cluster of the clusters of points meets a flatness threshold, perform at least one of symbol and character recognition for a region of the output of the camera corresponding to the cluster.

14. The vehicle of claim 13, wherein the controller is further programmed to:
refrain from performing symbol and character recognition for regions of the output of the camera corresponding to clusters of the clusters of points that do not meet the flatness threshold.

15. The vehicle of claim 11, wherein the controller is further programmed to:
perform obstacle detection using the point cloud; and
autonomously navigate the vehicle to a destination and avoiding any obstacles determined from performing obstacle detection.

16. The vehicle of claim 15, wherein the controller is further programmed to autonomously navigate the vehicle to the destination by activating at least one of a steering actuator, accelerator actuator, and a braking actuator.

17. The vehicle of claim 15, wherein the controller is further programmed to autonomously navigate the vehicle in conformance with information obtained from the at least one of the symbol and character recognition performed on the regions of the output of the camera corresponding to the one or more of the clusters of points.

18. The vehicle of claim 11, wherein the controller is further programmed to perform at least one of symbol and character recognition for the regions of the output of the camera corresponding to the one or more of the clusters of points by:
translating coordinates of points in the one or more of the clusters of points to two-dimensional pixel positions in the output of the camera, the regions including the two-dimensional pixel positions.

19. The vehicle of claim 11, wherein the controller is further programmed to identify the clusters of points in the point cloud obtained from the LIDAR sensor having reflectivity above the reflectivity threshold by:
identifying points in the point cloud having reflectivity above the reflectivity threshold; and
grouping the points into the clusters of points according to proximity of the points of each cluster of points to one another.

20. The vehicle of claim 11, wherein identifying the clusters of points in the point cloud obtained from the LIDAR sensor having reflectivity above the reflectivity threshold comprises:
removing points from the point cloud that correspond to a ground plane; and
identifying the clusters of points from among points of the point cloud that do not correspond to the ground plane.
